(19) United States
(12) Patent Application Publication
(10) Pub. No.: US 2022/0114529 A1
(43) Pub. Date: Apr. 14, 2022

(54) TRAINING AND RISK MANAGEMENT SYSTEM AND METHOD

(71) Applicant: 2234747 Alberta Inc., Calgary (CA)

(72) Inventors: Bruce Gilkes, Calgary (CA); Mark Deller, Calgary (CA)

(21) Appl. No.: 17/555,726

(22) Filed: Dec. 20, 2021

Related U.S. Application Data
(63) Continuation of application No. 16/722,049, filed on Dec. 20, 2019.

(51) Int. Cl. G06Q 10/06; G06F 16/41; G06N 20/00; G09B 9/00; G06F 16/45; G06V 40/10; G06V 40/20

(52) U.S. Cl. CPC G06Q 10/06395; G06F 16/41; G06N 20/00; G06V 40/20; G09B 9/00; G06F 16/45; G06V 40/10; G06Q 10/0635

(57) ABSTRACT

Training and risk management system and method are provided to improve team performance during trainings by simulating events for reducing risk to business. The system comprises computer simulation subsystem for simulating events in space and time for training, team performance measurement subsystem for evaluating the performance of the participants and computer vision subsystem for monitoring the participants' activities. A risk management platform contains a comprehensive asset list as required to build scenarios for risk simulations and allow access to other subsystems. Team performance can be continuously improved by feedback of the evaluation.

This application is a continuation of U.S. patent application Ser. No. 16/722,049, the disclosure of which is incorporated by reference.

### FIELD

This invention relates to training and risk management systems and methods, and more specifically to computer simulation training and risk management systems and methods having human participants to interact with.

### BACKGROUND

Business risk has been well recognized by stakeholders such as company owners, insurers, self-insurance entities, financial institutions, government, shareholders, etc. Risk costs are increasing significantly with fewer means of managing these costs. Typical risk strategies often utilize self-insurance and/or third party insurance. Third party insurers are seeing increased risk exposure, especially with risks around business interruption and business continuity aspects.

With respect to business interruption, many factors are currently unknown, such as the effectiveness of the client's emergency plan, the ability of personnel to understand and mitigate the various risks and the effectiveness of the client's staff in reducing loss or preventing further losses while being effective at recovery post risk event. As well there are many unknowns around second order effects such as the effect of third party business interruptions on the client's business.

Insurance costs are also rising because the loss ratios are becoming worse and insurance companies are starting to add restrictions and/or deny claims because of their increased risk. Disasters and emergencies are becoming more frequent and having greater effect due to urbanization, emerging middle class, and possibly climate change. Meanwhile, businesses are facing higher costs for losses with insurance covering only 50 percent on average. Even a small cyber incident can cost a small business $1.25 million of a $2.5 million claim.

A blind spot for insurance companies, financial institutions and businesses is the performance of the business during “High Impact, Low Frequency” events, such as disasters. More specifically, these high risk events are managed by people, and the success, failure, and amount of loss can directly be attributable to the personnel involved in the response. Meanwhile, businesses seldom test plans or exercise personnel in preparation for these events, and this leaves a large amount of risk that must be managed. Because the risk is difficult to quantify, both the business and their financial partners have a large amount of risk on their balance sheets, which, in turn, drives up costs.

Meanwhile, increasing globalization and urbanization is increasing the complexity of the environment in which businesses and government operate. Environmental change is also creating more risk for business and governments in the context of maintaining operations, managing profitability, and reducing potential loss of life.

For example, U.S. Pat. No. 7,991,729 to Lockheed Martin Corp., filed on Oct. 4, 2007, describes a system and a method for automating performance assessments of an exercise or a training activity. The system provides event assessment information in real-time to one or more evaluators in conjunction with unfolding events. The system includes a scenario workflow that defines events that are expected to occur. The assessment including the evaluator's remarks, comments and evaluations is recorded and stored. The applicable assessment criteria can be dynamically adjusted by the evaluator based on accomplishment of assessment objectives during the assessment session.

U.S. Pat. Application. No. 2014/0004487 to Cheben et al., filed on Mar. 12, 2012, describes a real-time immersive training system. The system includes an immersive visualization room that includes a rendering device configured to provide a three dimensional image of a workspace on a display surface. An operations console is configured to provide plant information to the rendering device and obtain operator input from an input device. A communications system is configured to interact with a dynamic process simulator. The dynamic process simulator provides simulated real time data of the workspace to the immersive visualization room and the operator console. It also provides parameter updates and accepts parameter input from the immersive visualization room.

U.S. Pat. App. No. 2018/0068582 to Lawrence Livermore National Security LLC., filed on Oct. 31, 2017, describes a simulation system useful for the experiences of the individuals participating in the simulated exercise that would be experienced during an actual emergency event. The simulation system comprises a signal generator for generating signals corresponding to the evolving scenario and a controller to cause the generator to generate the signals. The signals are used to simulated the emergency event and are provided to the user for experience.

### SUMMARY

There is a strong desire to develop systems and methods to better understand the risk as well as to provide training and risk management platform for improving efficiency of responding to high risk and low frequency events and reducing risk for varieties of stakeholders.

According to one aspect, a training and risk management method is provided, comprising: designing a computer simulation for simulating an exercise based on an exercise plan; building the computer simulation; collecting exercise data of participants of a team conducting the exercise; evaluating team performance of the team by comparing the exercise data with an evaluation plan; providing feedback for changes to one of the exercise plan, the evaluation plan, the team performance and any combinations based on evaluation of team performance; updating one of the exercise plan, the evaluation plan, the team performance and any combinations upon receiving the feedback.

According to another aspect, a training and risk management system is provided. The system comprises at least one server for storing a computer simulation subsystem, a team performance measurement subsystem (TPMS) and a risk management platform, and at least one electronic device for accessing the computer simulation subsystem, the TPMS and the risk management platform via Internet. The computer simulation subsystem includes a first computer program having instructions to simulate an exercise based on an exercise plan, and to receive exercise data of participants of a team conducting the exercise. The TPMS includes a second computer program having instruction to store evaluation plans, and to evaluate team performance. The risk management platform includes a third computer program having instructions to store source information for the simulation subsystem and source information for the evaluation plans, and to provide an application programming interface (API) that allows users to access the computer simulation subsystem and the TPMS via the local electronic device. The exercise plan, the evaluation plan and the team performance can be updated for changes upon receiving feedback of the evaluation of the team performance.

According to another aspect, the training and risk management system further comprises a computer vision subsystem for capturing and processing images or videos of activities of participants of the team conducing the exercise. The computer vision subsystem comprises an image/video gathering system for capturing the images or videos and an image processing subsystem for processing the images or videos. The image processing subsystem may process the images or videos for human recognition, human identification, activity recognition, role correlation, time/activity/process correlation and success correlation.

According to another aspect, a computer program product embodied in a computer readable storage medium that implements a method for training and risk management is provided. The computer readable storage medium may store computer programs of the computer simulation subsystem, the TPMS and the risk management platform for performing the designing of a computer simulation, building the computer simulation, collecting exercise data, evaluating team performance, providing feedback for changes to an exercise plan and an evaluation plan, and updating the exercise plan, the evaluation plan and the team performance based on the feedback.

This system of the invention measures team performance, and allows for continuous improvement to take place. It also allows decision makers and senior responders to practice their roles in a very realistic manner. Team performance measurement plus realistic practice allows personnel to become well-prepared for rare but impactful incidents and emergencies. Incident and emergency plans for rare events are seldom fully fleshed out and tested. Infrequent events are difficult to practice or because of the equipment involved the training can be unrealistic. This training system allows users to conduct realistic practice, using their actual communication system and following their actual emergency processes and procedures. It provides much more engaging tool to improve the efficiency to respond to emergencies or disasters and to reduce the risk of these events.

### DESCRIPTION OF THE DRAWINGS

While the invention is claimed in the concluding portions hereof, example embodiments are provided in the accompanying detailed description which may be best understood in conjunction with the accompanying diagrams and where:

FIG. 1 is a block diagram of a training and risk management system according to one aspect described herein;

FIG. 2 is a block diagram of a computer simulation subsystem of the training and risk management system of FIG. 1.

FIG. 3 is a block diagram of an exercise planning module of the training and risk management system of FIG. 1 interacting with a risk management platform and the computer simulation sub system;

FIG. 4 is a block diagram of a computer vision subsystem of the training and risk management system of FIG. 1 interacting with the simulation subsystem;

FIG. 5 is a block diagram of an image/video gathering system used for the computer vision subsystem of FIG. 4;

FIG. 6 is a block diagram of a team performance measurement subsystem (TPMS) of the training and risk management system of FIG. 1 interacting with the risk management platform;

FIG. 7A is an example of a main dashboard of the risk management platform;

FIG. 7B is an example of a sub-dashboard of the risk management platform;

FIG. 8 is a flowchart showing procedures of a risk management method according to one aspect;

FIG. 9 is a flowchart showing procedures of a plan/process testing and evaluation sub-process of the risk management method of FIG. 7;

FIG. 10 a flowchart showing procedures of a team/individual training sub-process of the risk management method of FIG. 7;

FIG. 11 is a block diagram showing an example of a computer simulation process for geographic information;

FIG. 12 is a block diagram showing another example of a computer simulation process for event injects by exercise designer;

FIG. 13 is a block diagram showing another example of a computer simulation process for weather, current and tidal information; and

FIGS. 14A-14E show methods to identify worldwide weather grid used for the computer simulation subsystem.

### DETAILED DESCRIPTION

Current risk management strategies are antiquated and are not able to leverage technology to help better manage risk. It is also difficult to measure a whole team performance during the training. There is not enough ability and efficiency for the companies to respond to the high risk emergencies and events. Current training tools normally allow the participants to follow the instructions of a training course or plan to perform designed actions. There are not interactions or feedback between the training plan designer and the participants in order to improve the training plan. Risk management industry needs to seek technological advancements that allow the stakeholders a better understanding of risk and a better means of risk reduction.

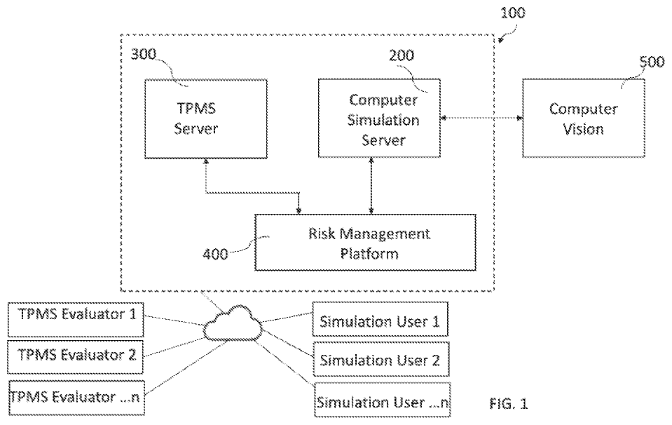

As shown in FIG. 1, a training and risk management system 100 may comprise three subsystems: a computer simulation subsystem 200, a team performance measurement subsystem (TPMS) 300, and a risk management platform 400 for access to the simulation subsystem 200 and the team performance measurement subsystem 300. The risk management platform 400 may have a dashboard containing a comprehensive asset list to build scenarios for the constructive operational risk simulations. The training and risk management system 100 may further comprise a computer vision subsystem 500 for monitoring participants' activities.

In one aspect, the training and risk management system 100 may be a cloud-based, multi-client system that may be deployed with several different customers. For example, as shown in FIG. 1, multiple simulation users and multiple TPMS evaluators may access to the training and risk management system 100 via the Internet. In another aspect, the multiple simulation users such as exercise designers may access the computer simulation subsystem 200 on a computer simulation server through local computers to design training or simulation events. On the other hand, multiple TPMS evaluators may access the TPMS 300 on a TPMS server via other local computes or handheld devices such as a table or mobile phone to evaluate the team performance after a training exercise.

The computer simulation subsystem 200 measures time, space, and actions to determine an optimization of response to a risk or set of risks. This subsystem 200 may be a modular, componentized simulation framework that may be easily extensible to simulate a wide variety contemplated events in space and time. The types of simulations may vary, for instance, from an intangible cyber-attack to a physical disaster such as an earthquake. The subsystem 200 may be designed to cause a client's personnel to perform tasks during an exercise similarly to how the client's personnel may perform during an actual emergency. This feature determines the client's actual readiness for the emergency. In this aspect, the subsystem 200 may be implemented on a cloud-based, multi-client system that may be deployed with several different customers as a stand-alone tool.

The TPMS 300 may measure the effectiveness of the team as the team performs a set of tasks during the training or exercise. One or more expert observers or evaluators may operate a TPMS checklist during the simulation and may note team performance using a set of specific and/or objective parameters. If a significant disagreement occurs between observers, the TPMS 300 may highlight one or more inconsistencies and may require the observers to homogenize their responses. The TPMS 300 may allow the clients or users to set up a baseline of team performance or to recommend a “Training Prescription” for correcting any identified deficiencies, and may allow for continuous performance improvement for individual participants and/or the team.

The TPMS 300 may be repeated more than once in a cyclical manner with the same team during different training events. The TPMS 300 may measure and track progress to facilitate continuous improvement (e.g. measure, make recommendations for improvement, and measure outcome of the recommendations).

The risk management platform 400 may facilitate a maintaining of an asset repository, an exercise development platform, and a key performance indicator (KPI) analysis environment. The risk management platform 400 may comprises application programming interface (API) that may access other subsystems such as the computer simulation subsystem 200 and the TPMS 300. The risk management platform 400 may comprise a dashboard having a comprehensive asset list as required to build scenarios for one or more constructive operational risk simulations. The asset repository may also contain parameters for each asset as required for the simulations and that may be applicable to a specific asset such as one or more geospatial locations, one or more fuel consumptions, one or more fuel capacities, one or more throughputs, one or more capacity limits, one or more equipment vintages, one or more equipment values, etc. The risk management platform 400 may be a cloud-based system that may be built out as a repository for each client and may represents a day-to-day interaction that the client has with the system. The risk management platform 400 may retain all of the client information and may display their training progress and risk management activities at a glance on the dashboard. The dashboard may be a standalone dashboard and/or may be integrated into the client's already-existing dashboards and management tools.

A computer vision subsystem 500 may monitor a time and a motion of the participants involved in the training or exercise such as an emergency or a disaster response, and may analyzes one or more movements for trends and/or correlation to one or more best practices, and/or an identification of one or more weaknesses in one or more team interactions. In one aspect, this subsystem 500 may produce a heat map of the movements of participants within an operations centre in order to correlate participant exercise data with participant activities to determine one or more best practices.

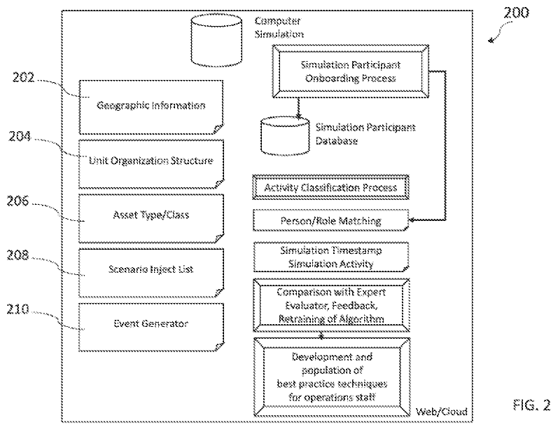

The above mentioned subsystems will now be described in detail with reference to FIGS. 2-6. FIG. 2 shows a block diagram of a computer simulation subsystem 200 for simulating an event or scenario. The computer simulation subsystem 200 is a web/cloud-based modular architecture. The subsystem 200 may simulate the event or scenario using one or more of: a plurality of information/lists, such as geographic information, organization structure, asset type/class, scenario inject list, and event generator. The simulation subsystem 200 may also comprise a plurality of processing modules to interact with the computer vision subsystem 500, and to receive feedback of activities of the exercise participants and to evaluate their performances, details of which will be discussed later.

In one accept, the simulation subsystem 200 may comprise a plurality of simulation modules to simulate events. In the example of FIG. 2, the simulation subsystem 200 comprise a geographic information module 202, an unit organization structure module 204, an asset type/class module 206, a scenario inject list module 208 and an event generator module 210.

The geographic information module 202 may be used to simulate a background map, which may essentially acts as intelligent “canvas” upon which many of the simulation activities occur. Some of the elements may be satellite photos, whereas some elements may be animation scenes.

The unit organization structure module 204 may be a combination of units and entities, which have capabilities and characteristics that act upon or be acted upon within the simulation. For instance, this module 204 may define different capabilities for a rule set for entities to interact with each other, such as what they can do (or not do) and what can occur to the entity under certain conditions (e.g. the truck running out of fuel may be much less significant than the aircraft).

Some of the information/elements may be able to be imported from a geographic information system (GIS). For instance, a hospital may be marked at a certain location and perhaps the building outline may be provided. However, GIS may not be able to provide the information about how many doctors or nurses may be in the hospital, what key equipment may be present, and how many patients of which type can be treated and in what amount of time. Such information may be provided from other sources and may be built into the simulation by manually entering the information. However it may be easier to import this information directly from the client's asset list. In this example, the asset type/class module 206 may comprise asset lists obtained from different clients. They may include people, equipment and vehicle. etc. for simulation designers to choose and build the customized simulations.

The scenario inject list module 208 may be used to inject a significant information event which are not geographic, such as a sudden announcement of emergency. This information event as a “scenario inject” can be delivered to the exercise participants in multiple forms such as a text message, a photo, a video, a voice on a radio, a simulated newscast, rolling news, an email, fax, an telephone call, or another delivery means—essentially the same as a human would expect to find out the information in a real world situation. These “scenario injects” may be delivered at a specific time (local time or exercise time), when a certain event happens, when a particular simulated entity reaches a certain geographic point, when a certain simulation entity type is within a certain distance of another entity type, and/or when one military force sights another military force, etc.

The event generator module 210 may provide simulation elements such as disasters (floods, fires, earthquake, etc.) which affect simulated entities but are not controlled by the exercise participants. These events can be mitigated or resolved by the participants controlling resources within the simulation (a participant can place sandbags to mitigate a flood) and this can provide feedback (not enough sandbags results in failing to hold back floodwaters) so that this process can be interactive. The event generator module 210 is not limited to simulate disasters, and could be used for anything incident of condition that may impact the exercise. For example, the weather becomes rainy and this turns a dirt road to mud and impacts movement.

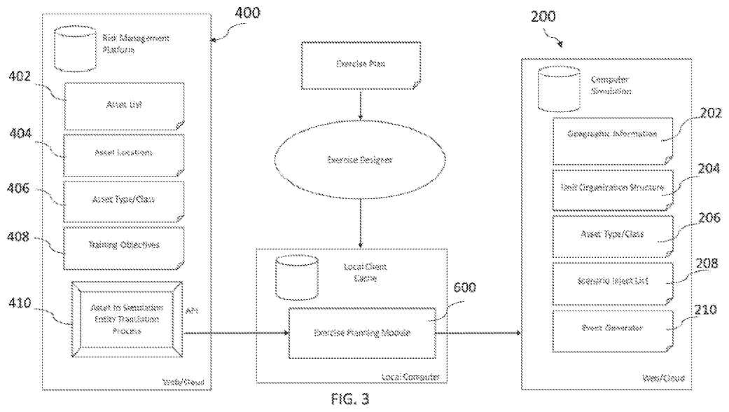

The sources of the information for simulation may be accessed via the risk management platform 400. The risk management platform 400 may also be web/cloud-based and may be available to various asset information, such as the asset list, one or more asset locations, one or more asset type/class, and/or one or more training objectives. The various information may be shown on a dashboard of a local computer. A training or exercise designer may be able to select the asset from the asset list based on the exercise plan at the local computer. The selected asset information may be processed and translated into simulation entities. The risk management platform 400 may include a plurality modules that store sources of information to be simulated. In the example of FIG. 3, the risk management platform 400 may comprise an asset list module 402 for storing a whole list of assets, an asset location module 404 for storing all asset locations, an asset type/class module 406 for storing all the asset types, a training objective module 408 for storing training objectives and an asset translation process module 410 for translating the assets into simulation entities.

In another aspect, the computer simulation system 100 may include an exercise planning module 600 that allows exercise designers to build a customized simulation of an exercise plan. The exercise planning module 600 may include a web interface/application at a local computer for uploading or importing information. FIG. 3 shows an example to build a simulation of an exercise plan by using the exercise planning module 600 to interact with the simulation subsystem 200 and the risk management platform 400. The web interface/application may allow the exercise designers to upload any selected information they require for their plan or selected information from the different modules of the risk management platform 400. The selected information is uploaded to the simulation subsystem 200 to simulate the exercise plan. The plan designer may choose a “Planning Mode” on the interface to conducts all the exercise planning, and after that at the appropriate time, may select the “Run Mode” on the interface to begin the simulation.

As a web application, some components of the information for simulation may be downloaded to the browser for execution, and some components may remain on the server side. The downloaded components may be used to improve local performance, reduce latency/delays, and/or allow for an optimal (e.g. speedy) user experience. The components that remain on the server may be used to improve synchronization between multiple entities, provide accurate and fully synchronized tracking of simulation events and timing, and to provide a centralized and easily accessible toolset.

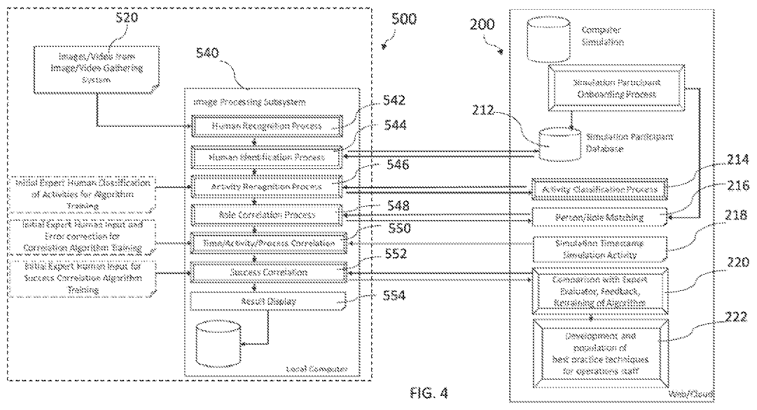

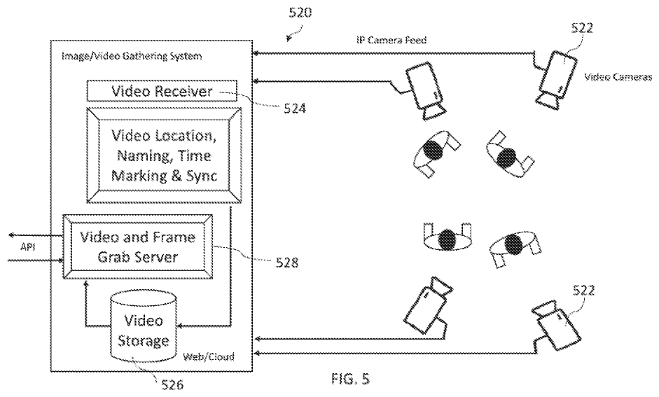

After the exercise plan has been designed and simulated, the participants may be able to conduct the exercise or training according to the exercise plan. In one aspect, the exercises or activities of the participants may be monitored or tracked by a computer vision subsystem 500 as shown in FIG. 4 and FIG. 5. The computer vision subsystem 500 may further comprise an image/video gathering subsystem 520 and an imaging processing subsystem 540. The image/video gathering subsystem 520 may include a plurality of video cameras 522 at the training scene for capturing images or videos of the activities of the participants. The captured images or videos may be received in a video receiver 524 and stored in a video storage 526, such as in a web/cloud storage. In some aspects, the video location, participant name, and time may be marked and synchronized, and stored in the video storage 526. The videos may be selected via an API from a video and frame grab server 528 and sent to the image processing subsystem 540 for further process.

In one aspect, the image processing subsystem 540 may be located at a local computer. The image processing subsystem 540 may include a plurality of image processing modules for processing the video images for recognition of the participants' identities and activities.

In the example of FIG. 4, the image processing subsystem 540 comprises a human recognition process module 542, a human identification process module 544, an activity recognition process module 546, a role correlation process module 548, a time/activity/process correlation module 550, a success correlation module 552 and result display component 554. The videos may go through all these process modules for image processing. For example, the images or videos may be sent to the human recognition process module 542 first for identifying the participant. Then the videos may be processed in the identification process module 544 for determining the participant's role and in the activity recognition process module 546 for determining the type of activities. The roles of the participant may be correlated with the activities in the role correlation process module 548. The time and activity/process of the exercise may be correlated with the role in the time/activity/process correlation module 550. Each role may be further correlated with an activity at a certain point/time during the exercise in the success correlation module 554. The final processed results may be shown on the display of the local computer via the result display component 554. For instance, as a result of the process, the roles could be “Incident Commander”, “Planning Lead”, “Operations Lead” or “Logistics Lead”, etc. The human recognition process may determine that “that's Bill Smith” and the role correlation process may determine that “Bill Smith is working as the Incident Commander”. Therefore, the performance of that participant may be assessed against that role. The time/activity/process may determine the time or phase of certain activity that are expected out of the participant according to that role.

In one aspect, the image processing executed in the process modules of the image processing subsystem 540 may be based on machine learning algorithms with initial human guidance/classification. For example, there may be initial expert human input for the algorithm training used for the activity recognition process, time/activity process or success correlation process.

In another aspect, the processed results after each module of the imaging processing subsystem 540 may be transmitted to the computer simulation subsystem 200 for verification. For example, the human identification data after the process of human identification process module 544 may be compared with the participant data in a simulation participant database 212 of the computer simulation subsystem 200. The activities processed by the activity recognition process module 546 may be verified by the data in an activity classification process module 214 of the computer simulation subsystem 200. The role correlation after the process of the role correlation process module 548 is compared with the data of a role matching module 216 of the computer simulation subsystem 200. The time and activity correlation after the time/activity correlation may be compared with timestamp of a simulation timestamp module 218 of the computer simulation subsystem 200. The success correlation module 552 may take and compare the known simulation outcomes, such as expert evaluation and feedback in a comparison module 220 of the computer simulation subsystem 200 during each activity, correlated against who was expected to do what at each point during the exercise. The comparison results then allows the designer or training manager to assess whether an individual participant's behaviors contributed or detracted from the overall success of the activity at that point in the simulation. The comparison may also be processed via a retraining AI algorithm and be provided to a development modules 222 of the computer simulation subsystem 200 for improvement and population of best practice techniques for each participant.

In one aspect, the retraining AI algorithm may been initially trained based on how expert evaluators grade a person's performance in their role versus the overall success or failure of the team within the simulation. This provides the initial training data. The next stage is that the expert evaluator may work in concert with the AI algorithm and essentially “grades higher” the algorithms performance in identifying beneficial interactions within the team, and between the team (specific roles) and other teams. The AI algorithm may provide a suspected rating for actions and roles and the expert may provide an independent opinion for the same. Where these correlate closely may be considered correct and these inferences from the AI algorithm may be given weighting for future simulation rating events. Where they do not correlate well, an evaluator may evaluate the inferences and determine which are correct, which are incorrect and which are unknown. The AI algorithm may also be trained with other multiple variables such as the type of team, the type of scenario, etc. The retraining AI algorithm may be able to identify these and pinpoint valid variables through scenario information, as well as opinions from the experts. Once the retraining AI algorithm has been well trained, it shows a high validity in the correlation between activities taking place (in each role) and the overall team success. The algorithm can be validated and applied in validated situations, such as those scenarios that have been tested and proven to be correlated. The AI algorithm then can provide feedback for teams and individual participants filling the roles.

In another aspect, the trained AI algorithm may provide an operational “expert system” to provide feedback and advice to non-experienced participants occupying critical roles during a disaster by observing their actions and providing recommended “best practices”. The feedback in both simulation and operational cases may be given with a % applicability and % estimated accuracy to the user.

In addition to the evaluation to each individual participant, the team performance of the exercise or training may also be evaluated based on an evaluation plan in TPMS. The TPMS may be used fully to baseline the various teams' strengths and weaknesses, and used to assess the team level of performance improvement against the baseline.

The team evaluation process measures, known best practices for high performing response teams. Some of these items being evaluated may include a checklist. For example, the checklist may comprise a number of questions such as “do you have a method to track personnel locations?”, “Do you have redundancy for 24-hour operations?” These questions may be answered using a measurement, such as a 5-point Likert scale with 1 being “not considered” to 5 being “A managed process is in place to ensure this is always done perfectly”.

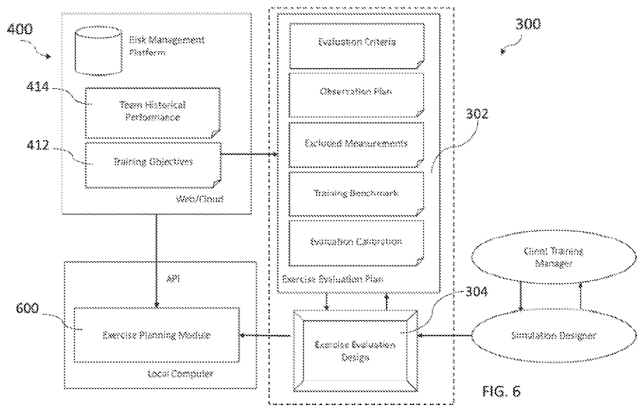

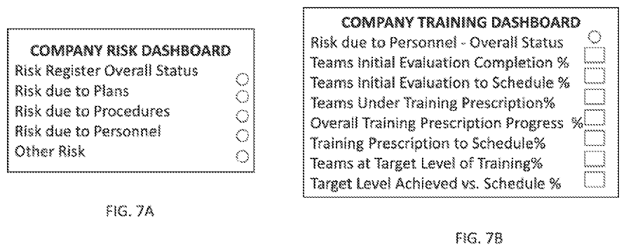

FIG. 6 shows a block diagram of the TPMS 300 interacting with the risk management platform 400 and the exercise planning module 600. This subsystem 300 may include an exercise evaluation plan module 302 for storing an evaluation plan. In one aspect, the plan may include a set of specific and/or objective parameters, such as the evaluation criteria, the observation plan, the excluded measurements, the training benchmark, and/or the evaluation calibration. These parameters and requirements may be created based on the training objectives 412 or team historical performance record 414 from the risk management platform 400. For example, the training benchmark may vary in each case according to what they are trying to accomplish versus their skill level and the type of exercise. The Evaluation calibration may be conducted to confirm that the evaluators rate the same conditions in the same manner. The risk management platform 400 may have customized design dashboard for ease of operation of different types of exercises or trainings. For example, the risk management platform 400 may have a main dashboard that lists all possible categories of risks that need to be improved, such as risks due to plans, risk due to procedures, risk due to personnel and other types of risks. In another aspects, under each category, there may be a sub-dashboard to show the status and progress of the training related to that risk, such as the status of initial evaluation completion, initial evaluation to schedule, analysis of the evaluation, revision of analyzed plans, retesting of analyzed revised plans, finished plans overall completion and finished plans to the designed schedule etc. Each finished item may be presented in a form of percentage level in terms of the schedule. FIG. 7A is an example of the main dashboard showing the items of risk register overall status, risk due to plans, risk due to procedures, risk due to personnel and other risk. FIG. 7B shows an example of a sub-dashboard under the item of risk due to personnel of FIG. 7A. The sub-dashboard of this example includes a list of items that can be represented in a form of percentage level, such as overall status of the risk due to personnel, teams initial evaluation completion, teams initial evaluation to schedule, teams under training prescription, overall training prescription progress, training prescription to schedule, teams at target level of training and target level achieved in comparison to the schedule.

In another aspect, the TPMS 300 may also include an exercise evaluation design module 304 for designing and creating the exercise evaluation plan. The exercise evaluation plan may be created based on a combination of the desired goals and objectives, with the exercise design. The exercise evaluation plan may be designed to evaluate the team undergoing training (much like a teacher creates a test to evaluate knowledge taught in the classroom). The exercise evaluation plan may work hand in hand with the exercise design to create the conditions whereby an evaluation is possible. For instance, if the exercise or training intended to evaluate participants' ability of plan, an exercise of planning is designed so that it would lead the participants into a situation where they would have to realistically create a plan. The evaluation plan may include general components of planning, such as the basics of planning and checklists for planning as well as specific components to that particular exercise. If the exercise is an observation plan for participants to observe “Who does what”. The evaluation plan is designed to evaluation participants' observation ability. The evaluation plan may also be evaluated by the simulation designer or training manager to determine which of the standard criteria would be included, which would be excluded, and which specific criteria would need to add to the tool.

In another aspect, the TPMS 300 may be used as a measurement tool to evaluate risk, in parallel with the computer simulation subsystem 200 and exercise planning module 600. For example, the TPMS 300 can be used to measure and manage exercises related to personnel. The TPMS may measure participants' capacity and capability to respond during rare but impactful events. With procedures and policy exercises, TPMS may not be used. Instead, the simulation subsystem 200 may measure the success of their plans and procedures based on outputs from the simulations (e.g. amount of time to extinguish the fire, ability of resources to deal with the situation, number of vehicles involved, amount of fuel used,

In a further aspect, the TPMS may include an application run on a mobile phone to allow the plan designer/trainer/evaluators to observe the exercise, add/edit/delete any comments or annotations at any particular time stamp during the exercise or provide side notes as desired, as certain exercises may be conducted. These comments or notes may be gone through by the designer/trainer/evaluator as a part of the checklists for evaluation.

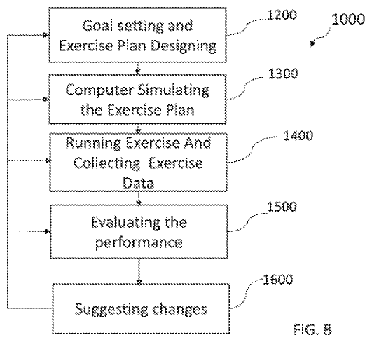

A method of managing a risk or training using the risk management system 100 is described with reference the flowchart 1000 of FIG. 8. First, a goal of an exercise for preventing a risk is set and an exercise plan is designed for achieving the goal at 1200. Once the exercise plan is developed, information related to the exercise plan is collected and input into a simulation subsystem for simulating the exercise plan at step 1300. After the participants conduct the exercise at the scene, their exercise data are collected at step 1400. The performance of each individual participant and the whole team is evaluated against the set goal at step 1500. The performance is then analyzed and changes may be suggested at step 1600. Feedback of the changes may be provided to each participant to improve their performance, to the whole team to improve the team performance, to exercise designers and the evaluators to improve the design plan and evaluation plan. The changes may include key parameter changes for the plan and the simulation subsystem to rebuild the simulation. The changes may also include evaluation standards that feed to the evaluation subsystem for updating the evaluation plan.

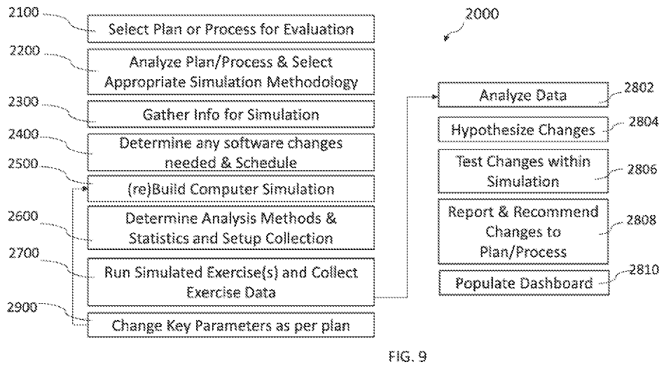

FIG. 9 is a flowchart showing an example of a plan & process testing and evaluation process 2000. Once a plan or process for evaluation has been selected at step 2100, the plan or process is analyzed and appropriate simulation methodology may be selected at step 2200. The information for building the simulation is gathered at step 2300. The information may be selected from the asset list of the risk management platform, pervious plan/process, geopathic information repository or from individual personnel. When necessary, any software changes to include new components for simulation may be needed at step 2400. The computer simulation is then built at step 2500. Analysis and evaluation method is also determined and the initial setting for the analysis is setup at step 2600. Then the exercise is run and exercise data is collected at step 2700. For an exercise of planning or process, the exercise may also be conducted with computer simulations to build the plan according to the objectives. The exercise data is then analyzed at step 2802. Hypothesize changes are proposed at step 2804. The changes are input into the simulation subsystem to test at step 2806. After test, a report of changes to the plan/process is recommended at step 2808 and may be populated on the dashboard at step 2810. The key parameter changes are then determined at step 2900 and fed back to the simulation subsystem to rebuild the computer simulation.

The process 2000 of FIG. 9 may also be a cyclical process in order to test a plan in a semi-automated manner over a plurality of iterations in order to collect and process statistical information for further analysis. For instance, the plans/processes/procedures may be tested in different temperatures, road conditions, wind directions, different vehicles, variations in personnel availability, different sizes of incidents, and/or types of incidents, etc. Multiple iterations of simulations under multiple conditions may be conducted and then a detailed statistical analysis may be performed on the data to determine largest impacts, largest mitigators, and/or cost drivers. After several repetitions, an optimal process or plan may be obtained. The statistical analysis may comprise at least one of: multivariate, regression testing (linear and non-linear), and/or Kalman filtering to highlight and determine the operational effects of minor but important data items. In some aspect, an artificial intelligence (AI) algorithm may make inferences from the massive data accumulated from the simulations. The AI algorithm may reduce the ongoing analytical burden.

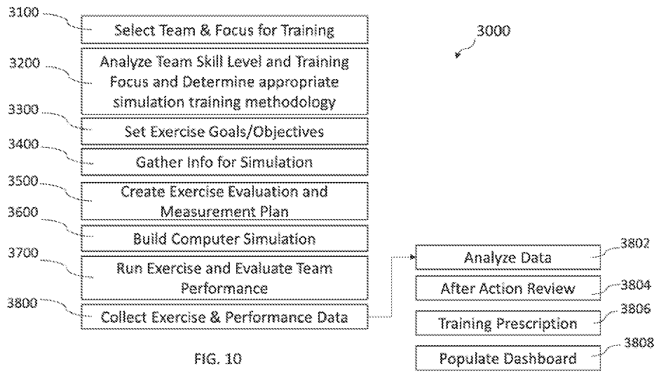

FIG. 10 is a flowchart showing an example of a team and individual training and evaluation process 3000. A team and focus of the training is selected at step 3100. The team skill level is analyzed and appropriate simulation training methodology will be determined at step 3200. Training goals/objectives are set at step 3300. The information for building the simulation is gathered at step 3400. The information may include participants, location, plans, map data and other related information for the training. An exercise evaluation and measurement plan is created at step 3500. The computer simulation is then built at step 3600. The exercise is run and the team performance is evaluated at step 3700. The exercise data from videos of the activities performed by the participants as discussed above is collected at step 3800. The exercise data is then analyzed at step 3802. The activities and team performance are reviewed after the exercise at step 3804. The training or exercise prescription is provided at step 3806 and may be populated on the dashboard at step 3808. The prescription may be used to improve the performance of the participants and the team.

The risk management system of the present invention may simulate varieties of information involved in an event or exercise. The information may include maps, photos or images of a scene for the event, terrain, height, vector data, different building layers and different identities. Disasters, incidents, emergencies or any other inject or notification may also be added.

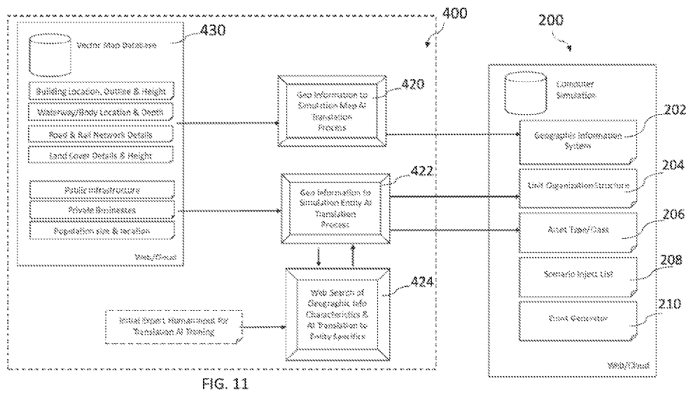

FIGS. 11-14 shows examples of generating the simulations from different types of information. FIG. 11 is a block diagram showing a simulation process of automatic population of computer simulation from geographic information. In this example, a map database 430 storing geographic information may be available via the Internet. The geographic information data in the database may include data of one or more building locations, outline and height, one or more waterway locations and depths, one or more road and/or rail network details, one or more land cover details and height, as well public infrastructure, private business, and population size and location. When a desired training or exercise scene has been planned by the exercise designer, the characteristics of the geographic information of the training scene may be searched on the map database. The desire geographic information may be chosen and processed to translate to simulation entities. For example, some information such as the building location, outline and height, waterway location and depth, road and rail network details, land cover details and height may be selected and translated to the simulation map via an simulation map artificial intelligent (AI) translation module 420. Some data such as public infrastructure, private business and population size and location may be translated to one or more simulation entities via a simulation entity AI translation module 422. All the translated identities may be sent to the computer simulation subsystem 200 and stored into a simulation entity database. In particular, the translated simulation map may be sent to a geographic information module 202, and the translated simulation entities may be sent to an unit organization structure module 204 and an asset type/class module 206 of the computer simulation subsystem 200. In another aspect, the risk management platform 400 may provide a web search module 424 for searching geographic information and its related characteristics. For example, census data around that geographic location may be used to determine how many people live in a neighborhood, their ages and percentage of the population of handicapped or limited mobility. It may help automatically populate the neighborhood with the correct number of people with an approximately correct distribution for exercise design process.

In one aspect, the map database 430 and the plurality of artificial intelligent translation modules may be included in the risk management platform subsystem on a web server.

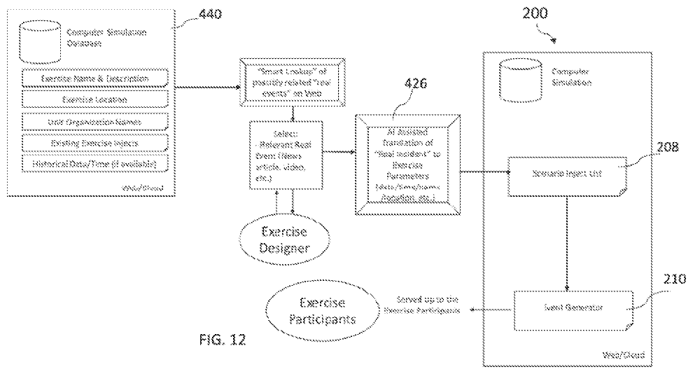

FIG. 12 is a block diagram showing an example of a simulation process of automatic population of event injects. The simulation is designed based on a relevant real event. The exercise designer may select a relevant real event from news, article or videos and search for possible related events on a computer simulation data base 440. The data base 440 may be in the risk management platform 400. Once the related events are selected, they are sent to an AI translation module 426 to translate into simulation parameters, such as date, time, location of the event and the name of the personnel. These exercise parameters are added into the scenario inject list 208 of the computer simulation subsystem 200, and then sent to event generator 210 for simulating the real event.

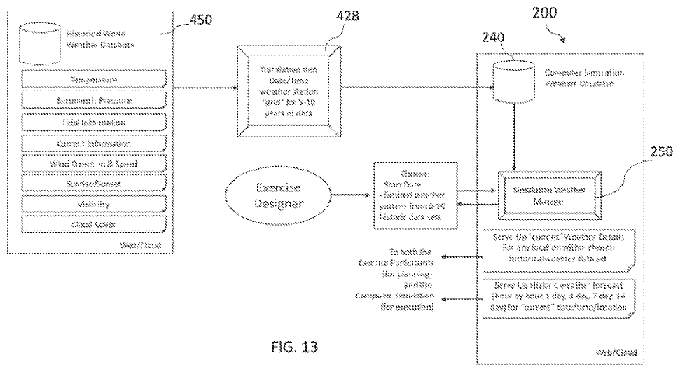

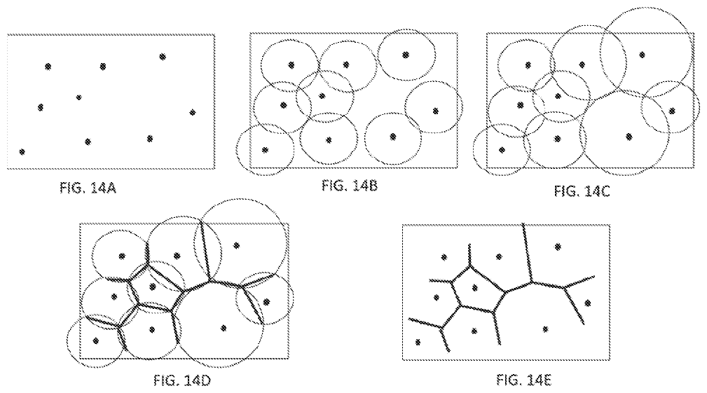

When an area of the world is selected for a simulation exercise, data from that area is populated into the simulation platform, such as the geographical information and identities of the simulation as discussed above. Vector data such as date, time and personnel of an event is also ingested for where schools, hospitals, roads, waterways, etc. are located. Similarly, weather information may also be added for that particular area of the world. FIGS. 13 and 14A-14E show an example of a simulation process of automatic population of weather, current and tidal information. Unlike other simulation systems that everything within the simulation is experiencing the same weather, the risk management system of the present invention may use real historical weather data in order to make the simulation accurate and realistic. The historical weather data usually comes from a plurality of weather stations located around the world, represented by the points shown in FIG. 14A. In order to associate the exercise location with the weather in that area, a worldwide weather grid or “geofence” has been constructed. A circle area around each station is generated. A mean distance between two weather station points is calculated as shown in FIGS. 14B and 14C. An intersection line between two adjacent circle areas can be found, and a dividing line is provided between each weather station, as shown in FIG. 14E. The final grid or geofence is then determined as shown in FIG. 14E. The geofence defines an area of entity locations associated with weather in that area, and the entities are impacted by weather in that area.

The weather information associated the area of entity locations may be stored in a historical world weather database 450 of the risk management platform 400. The weather information may include temperature, barometric pressure, tidal information, current, wind direction and speed, sunrise/sunset, visibility and cloud cover etc. The information may then be translated into weather simulation data based on the grid at a weather translation module 428. The translated data may be sent to a computer simulation weather database 240 of the computer simulation subsystem 200. The translated date may be processed in a simulation weather manager 250 for simulation. During a design of an exercise, an exercise designer may select the weather historic data for 5-10 years from the historical world weather database for computer simulation. The weather information may also be provided to exercise participants to plan their exercise.

Although the steps of the various methods described herein are demonstrated in a particular order, one of skill in the art upon reviewing the present disclosure may understand that the order of the steps may be altered without affecting the method. Also, some of the steps may be performed in parallel rather than serially.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A training and risk management method comprising:
designing a computer simulation for simulating an exercise based on an exercise plan;
building the computer simulation;
collecting exercise data of participants of a team conducting the exercise;
evaluating team performance of the team by comparing the exercise data with an evaluation plan;
providing feedback for changes to one of the exercise plan, the evaluation plan, the team performance and any combinations based on evaluation of team performance;
updating one of the exercise plan, the evaluation plan, the team performance and any combinations upon receiving the feedback.

2. The method of claim 1, wherein the designing step comprises gathering information including geographical information, asset type of entities, scenario inject, event inject and weather related to the geographical information.

3. The method of claim 2, wherein the designing step further comprises translating the gathered information into simulation entities and storing the simulation entities into different categories of a database.

4. The method of claim 3, wherein building the computer simulation comprises selecting exercise simulation entities from the database.

5. The method of claim 1, wherein the step of collecting exercise data comprises capturing images or videos of activities of the participants conducting the exercise.

6. The method of claim 5, further comprising processing the images or videos for human recognition, human identification, activity recognition, role correlation, time/activity/process correlation and success correlation.

7. The method of claim 6, comprising processing the images or videos based on artificial intelligent training algorithm with initial human input, and generating processed data.

8. The method of claim 7, wherein the evaluating step comprises comparing the processed data with the evaluation plan.

9. The method of claim 8, wherein the evaluating step comprises evaluating performance of each activity of each participant at certain time and certain exercise point during the exercise.

10. A training and risk management system comprising:
at least one server for storing a computer simulation subsystem, a team performance measurement subsystem (TPMS) and a risk management platform;
at least one electronic device for accessing the computer simulation subsystem, the TPMS and the risk management platform via Internet;
wherein the computer simulation subsystem includes a first computer program having instructions to simulate an exercise based on an exercise plan, and to receive exercise data of participants of a team conducting the exercise;
the TPMS includes a second computer program having instruction to store evaluation plans, and to evaluate team performance; and
the risk management platform includes a third computer program having instructions to stores source information for the simulation subsystem and source information for the evaluation plans, and to provide an application programming interface (API) that allows users to access the computer simulation subsystem and the TPMS via the local electronic device; the exercise plan, the evaluation plan and the team performance being updated for changes upon receiving feedback of evaluation of the team performance.

11. The system of claim 10, further comprising an exercise planning module having a web interface available at a local computer for importing source information for building a simulation.

12. The system of claim 11, wherein a plurality of types of source information from the risk management platform are available for selection via the web interface and are translated into simulation entities.

13. The system of claim 10, further comprising a computer vision subsystem for capturing and processing images or videos of activities of participants of the team conducing the exercise; the images or videos being sent to the simulation subsystem after processed in the electronic device.

14. The system of claim 13, wherein the computer vision subsystem comprises an image/video gathering system for capturing the images or videos and an image processing subsystem for processing the images or videos.

15. The system of claim 14, wherein the image processing subsystem include instructions to process the images or videos for human recognition, human identification, activity recognition, role correlation, time/activity/process correlation and success correlation.

16. The system of claim 10, wherein the computer simulation subsystem comprises instructions to evaluate a performance of each activity of each participant at certain time and at certain exercise point during the exercise.

17. The system of claim 10, wherein the TPMS includes instructions to measure the team performance according to a checklist of the evaluation plan on a 5-point Likert scale.

18. The system of claim 10, wherein the risk management platform includes a main dashboard showing a plurality of choices of exercise plans to be conducted and a plurality of sub-dashboards showing status and progress of the exercise being conducted.

19. The system of claim 10, wherein the TPMS includes a web application program executable at a mobile device.

20. A computer program product embodied in a computer readable storage medium that implements a method for training and risk management, the method comprising:
designing a computer simulation for simulating an exercise based on an exercise plan;
building the computer simulation;
collecting exercise data of participants of a team conducting the exercise;
evaluating team performance of the team by comparing the exercise data with an evaluation plan;
providing feedback for changes to one of the exercise plan, the evaluation plan, the team performance and any combinations based on evaluation of team performance;
updating one of the exercise plan, the evaluation plan, the team performance and any combinations upon receiving the feedback.
